(19) United States
(12) Patent Application Publication
(10) Pub. No.: US 2010/0056093 A1
(43) Pub. Date: Mar. 4, 2010

(54) RADIO FILTERS FOR XM CHANNELS

(75) Inventors: Robert C. Bannick, Waterford, MI (US); Matt C. Videtich, Farmington Hills, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: General Motors Corporation, Detroit, MI (US)

(21) Appl. No.: 12/201,913

(22) Filed: Aug. 29, 2008

(51) Int. Cl. H04B 1/10

(52) U.S. Cl. 455/297

(57) ABSTRACT

A method of providing user-defined satellite radio filtering in a satellite radio system entails receiving at the satellite radio system a user-defined filter specifying one or more satellite channels to block and, when receiving satellite radio signals, making the one or more satellite channels to block unavailable for listening by the user. The user-defined filter may be received via direct user input, a portable storage device, or a wireless network.

### TECHNICAL FIELD

The invention relates generally to radio systems and, more particularly to a system for allowing vehicle users to create, manage, and apply filters for satellite digital audio radio offerings.

### BACKGROUND OF THE INVENTION

As motor vehicles increase in sophistication and usefulness, on-board entertainment options are becoming more prevalent. One such entertainment option is satellite radio reception capability. However, current satellite radio systems do not allow sufficient flexibility to provide a full user experience.

For example, a vehicle owner who wishes to control their satellite radio content is currently unable to do so effectively and easily. At present satellite radio customers can turn off certain music categories in their vehicle, however, these categories are predetermined by the customer's satellite radio provider. If a customer wishes to unsubscribe to a particular channel, they must physically unsubscribe by calling and notifying their satellite radio provider. Moreover, after notifying their provider, the vehicle must be in a physical location that is accessible by the provider's wireless network, which performs the actual un-subscription. For example, if the vehicle is in an underground parking lot or tunnel which lacks wireless reception from the satellite radio provider, the requested channels cannot be unsubscribed. Thus, current technology poses an inconvenience to customers who wish to turn on/off specific satellite radio stations while inside their vehicle, without needing to contact their satellite radio provider.

### BRIEF SUMMARY OF THE INVENTION

The disclosure describes a method of providing user-defined satellite radio filtering in a satellite radio system including receiving, at the satellite radio system, a user-defined filter specifying one or more satellite channels to block and, when receiving satellite radio signals, making the one or more satellite channels to block unavailable for listening by the user. The user-defined filter may be received via direct user input, a portable storage device, or a wireless network.

The ability to control satellite radio content effectively and easily allows many benefits, e.g., allowing vehicle owners to restrict the radio content received by rear-seat passengers (e.g. parents may wish to prevent explicit language content from reaching their children). Front-seat passengers may also want to avoid the possibility of tuning to a channel broadcasting explicit content while seeking through radio channels. Currently, front-seat passengers who wish to control content received by the RSA system have no options other than turning off the entire radio system or physically unsubscribing to certain channels. The invention permits customers to develop and apply customized filters, providing convenient control of content.

### BRIEF DESCRIPTION OF THE SEVERAL VIEWS OF THE DRAWINGS

FIG. 1 is a schematic view of an example communication system within which examples of the disclosed system may be implemented;

FIG. 2 is a flowchart describing a process for a satellite radio filter to determine channels to block in accordance with a user-defined filter file;

FIG. 3 is an illustration of the methods by which a user can develop and copy filter files to a vehicle satellite radio system;

FIG. 4 illustrates an exemplary layout of a web interface through which a user may develop a filter file;

FIG. illustrates an exemplary user interface of a vehicle satellite radio system control panel; and

FIG. 6 illustrates a progression of soft key menus on a vehicle satellite radio system control panel.

### DETAILED DESCRIPTION OF THE INVENTION

Before describing the invention in detail, an exemplary environment in which the invention may operate will be described. It will be appreciated that the described environment is for purposes of illustration only, and does not imply any limitation regarding the use of other environments to practice the invention.

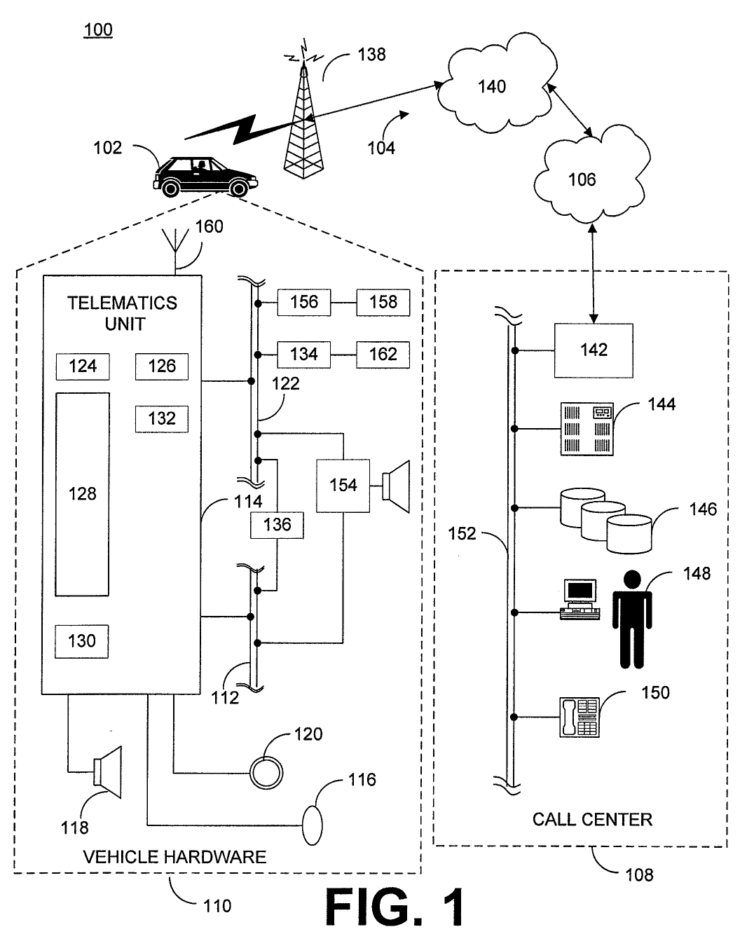

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

It will be appreciated that the processes discussed herein as being executed on a device are executed by a processor which reads computer-executable instructions from a computer-readable medium and executes those instructions. Media that are readable by a computer include both tangible and intangible media. Examples of the former include magnetic discs, optical discs, flash memory, RAM, ROM, tapes, cards, etc. Examples of the latter include acoustic signals, electrical signals, AM and FM waves, etc. As used in the appended claims, the term “computer-readable medium” denotes only tangible media that are readable by a computer unless otherwise specifically noted in the claim.

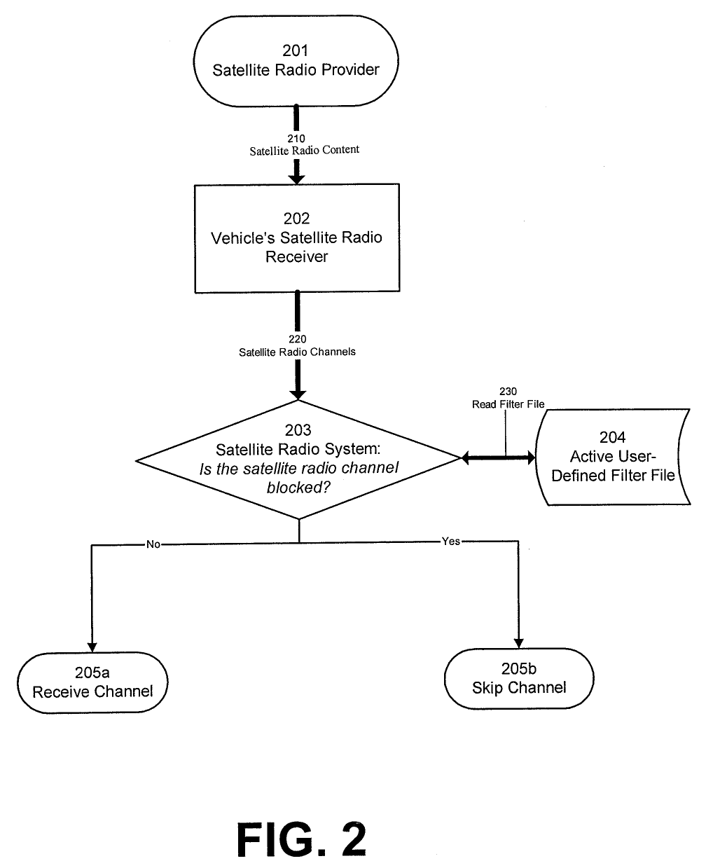

Referring now to FIG. 2, there is presented a flowchart describing a top-level view of a process architecture by which the satellite radio filter operates in one implementation. Satellite radio provider 201 broadcasts radio content 210 via multiple modulation schemes to a vehicle satellite radio receiver 202. The vehicle satellite radio receiver 202 acquires satellite broadcasts and demodulates the signals into channels to which the satellite radio receiver 202 tunes. In accordance with one aspect, the demodulated satellite channels are listed by positive integers.

Following this mapping procedure, the satellite radio channels 220 are then received and streamed to the vehicle's satellite radio system 203. The satellite radio system 203 includes as components, (1) a hard disk storage device to contain a filter file 204 and (2) a computer processor to conduct operations, including determining whether a particular channel is blocked. The satellite radio system 203 determines whether each satellite channels it receives are either blocked or playable. As part of this determination, satellite radio system 203 will consult the currently active user-defined filter file 204 that is presumably stored in the satellite radio system 203's hard disk. The filter file 204 will contain a computer-readable numeric listing of which satellite radio channels have been blocked by the user.

In one example, the satellite radio system 203 reads the entire filter file beforehand and store the blocked or unblock status of each satellite radio channel. In one example, if a channel is not defined as blocked in the filter file 204, the satellite radio system 203 will reach result 205a; the satellite radio system 203 will receive and play the satellite radio channel when the user has selected that particular channel using their satellite radio system 203's channel tuner. Continuing this example, if a channel has been defined as blocked in the filter file 204, the satellite radio system 203 will reach result 205b; the satellite radio system 203 will skip over this particular channel when the user has selected that particular channel using their satellite radio system 203's channel tuner.

By default, no filter file is turned on initially on the satellite radio system 203 prior to user activation of one or more filters. In the event that no user-defined filter file is stored in satellite radio system 203's hard disk, or no filter file is turned on, the satellite radio system 203 resorts to its default settings. Consequently, all satellite radio channels 220 will be playable since all are unblocked.

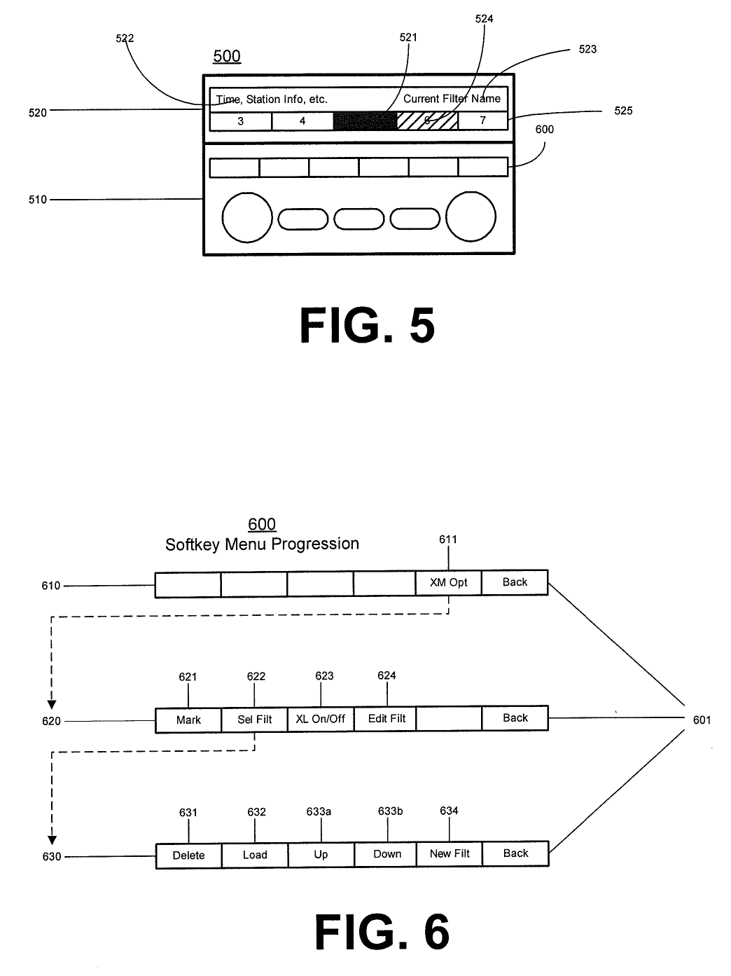

In an example, the hard disk storage device may have sufficient capacity to store a large number of user-defined filter files, e.g., more than 1000. However, at any given time, there will in this example only be one active user-defined filter file 204. It is only the active user-defined filter file which the satellite radio system 203 will query in order to determine whether to block or receive a given satellite radio channel. The selection of which filter file is active is determined by the user and illustrated in the detailed description of FIG. 6. In an alternative arrangement, multiple filters may be active.

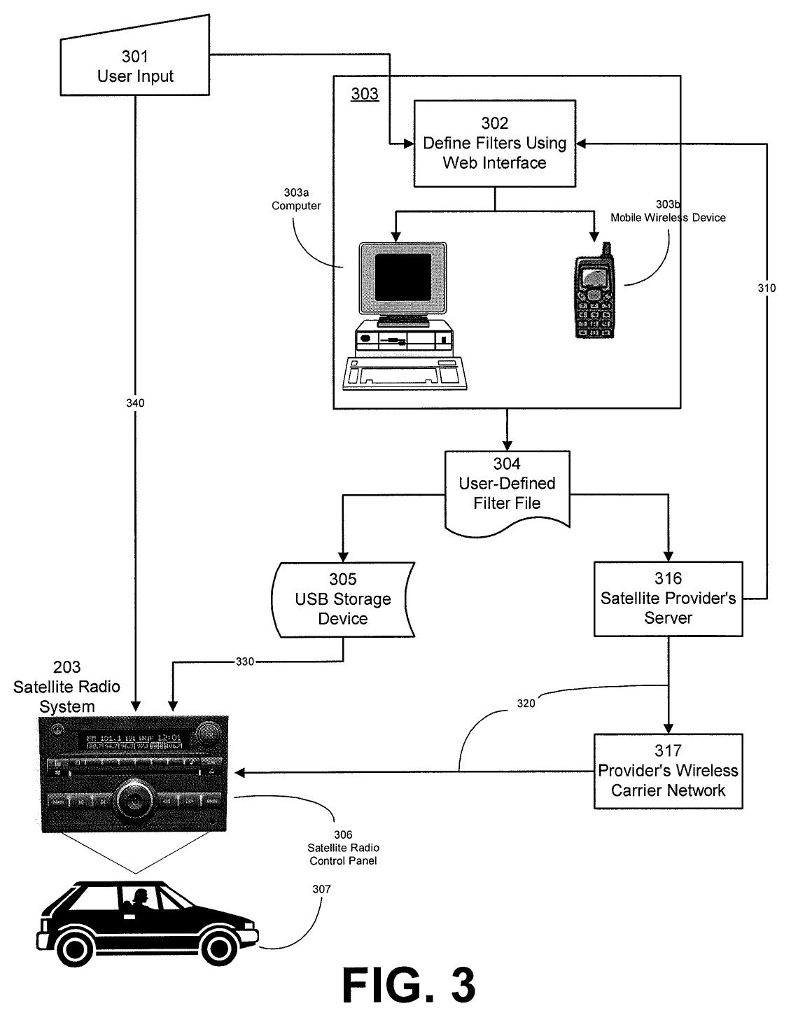

Referring now to FIG. 3, there is presented an illustration of exemplary methods by which a user can develop and load their user-defined filter onto the vehicle satellite radio system 203. The user may be able to develop and load their user-defined filter using all of these methods, each of which are described below.

The user's input 301 may create, modify, or delete their filter directly using the vehicle's satellite radio control panel 306, which is part of the vehicle's satellite radio system 203, which in turn is inside the user's vehicle 307. Through this approach, labeled as 340 in FIG. 3, the step of the user defining the filter is merged into the loading step, since the filter is defined directly on the vehicle's satellite radio system 203. In other words, there is no need to copy a user-defined filter file from an external location to the vehicle's satellite radio system 203. An example of the way in which the satellite radio control panel 306 may be used to create, modify, and delete filters is described in the detailed description of FIG. 6.

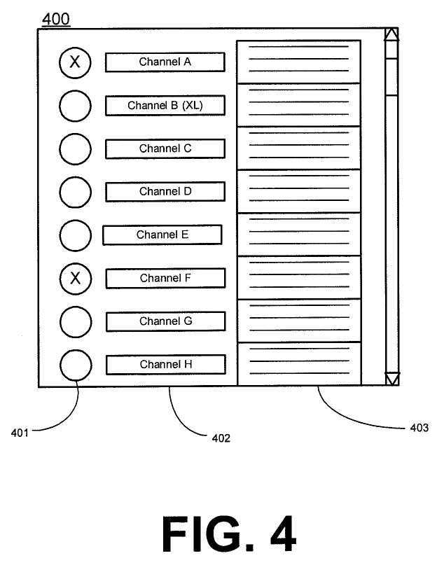

Additionally or alternatively, the user input 301 may create, modify, or delete a filter file 304 using a web interface 302 running on a computing device 303 with Internet access and a web browser. An example of the web interface 302 is described in the detailed description of FIG. 4. The web interface is a dynamic webpage with an associated Uniform Resource Locator (URL). The URL's domain name maps to the network location of the satellite radio provider's server 316. As those skilled in the art will understand, server 316 contains hard disk storage, memory, processing, and networking resources that permit server 316 to store information about the satellite provider's customers, including their filter files 304. Further, Internet connection 310 permits the user's computing device 303 and the server 316 to communicate data and messages to each other.

When the user enters the web interface 302's URL into a web browser, the user's computing device 303 running the browser will send a Hypertext Transfer Protocol (HTTP) request for web interface 302 to the satellite provider's servers 316 via Internet connection 310. As those skilled in the art will understand, the server 316 will respond to computing device 303's HTTP request by sending back an HTTP response. Server 316's HTTP response includes the requested web interface 302 via Internet connection 310. The webpage is loaded onto the user's browser window and is then employed by the user to define a filter file 304.

In an alternative example, interface 302 may instead be a software application which similarly presents the user an interface by which the user can define their filter file 304. However, the web interface may be generally more convenient since this permits the user to define their filter file 304 using any computing device 303 with Internet access and a web browser. In contrast, a software application can only be run on a computing device 303 where the software application is installed. Further, a software application necessarily places greater demands on the computing device 303's storage and memory resources.

As mentioned, the web interface 302 can be run on any computing device 303 with Internet access and a web browser. FIG. 3 presents two example devices, a personal computer 303a and a handheld wireless mobile device 303b. With any computing device 303, after the user has defined and submitted their filter file 304 using web interface 302, the web interface 302 transmits a copy of the user's filter file to server 316, where it is then stored in server 316's hard disk storage. In the disclosed example, when the provider's servers 316 detect the submission or modification of filter files 304 stored in its hard disks, it transmits these changes to the user's satellite radio system 203 via its wireless carrier network 317.

In this situation, each of the satellite radio provider's subscribers will have a user account. As understood by those skilled in the art, each user account will hold profile information about the user, including the user's filter files 304. These files 304 meanwhile are stored in a unique user-specific directory location in the provider server 316 hard disk.

When a user creates, changes, or deletes a filter file 304 using web interface 302, these modifications are immediately recorded to the user's account stored on the provider's servers 316. Modifications to filter files 304 trigger the provider's servers 316 to transmit the user's modifications to that user's satellite radio system 203, located in their vehicle 307. As understood by those skilled in the art, information about the network address of the user's satellite radio system is a component of the user's account and stored in the provider's server 316. Transmission is conducted via the provider's wireless carrier network 317. Following this wireless transmission process, labeled 320 in FIG. 3, a copy of the user-defined filter files 304 are stored on the satellite radio system 203's hard disk.

In an example, the web interface 302 will provide the user the option of saving their filter files 304 onto the local hard disk of their computing device 303. If the user chooses to save their filter files 304 onto the local hard disk, they may also copy these filter files 304 onto a portable USB storage device 305 that is connected to their computing device 303. The user may then connect the USB storage device 305 to their vehicle's satellite radio system 203 as indicated by label 330. In this example, it is assumed the vehicle's satellite radio system 203 contains USB ports, which permit USB devices to be connected to the vehicle's satellite radio system 203. The user may then copy the filter files 304 from the USB storage device 305 to the hard disk storage of satellite radio system 203.

Transfer via USB storage device 305, as compared to transfer via the provider's wireless carrier network 317, avoids some of the reliability issues commonly associated with wireless networks. Specifically, wireless networks may be unable to transfer data or have its wireless signal distorted due to interference. In particular, if the user's vehicle 307 is located in an area with limited wireless access (e.g., in a basement parking garage, inside a tunnel, etc.), then the wireless carrier network 317 signals may fail to reach the vehicle 307. While these problems rarely occur, they are completely avoided by use of a USB storage device 305. However, transfer of filter files 304 using a USB storage device 305 is generally more inconvenient for the user as compared to transfer using the provider's wireless network 317. The user must (1) save a local copy of the filter files 304 on their computing device 303 and (2) physically carry the USB storage device 305 from their computing device 303 to their vehicle 307. When the carrier's wireless network 317 is able to access user's vehicle 307 without excessive interference, this method of transferring the filter files 304 from the user's computing device 303 to the user vehicle's satellite radio system 203 requires less time and effort from the user.

To summarize FIG. 3, an example of the invention shows multiple methods by which the user can define their satellite radio filter file 304, and thereafter copy their filter files 304 to their vehicle's satellite radio system 203. As indicated by label 340, the user may directly define their filter file 304 using the vehicle's satellite radio control panel 306. Alternatively, the user may define their filter file 304 using a web interface 302. The web interface 302 can run on any computing device 303 with Internet access and a web browser. After defining their filter files 304 on a computing device 303, the user may copy the filter files 304 to their vehicle's satellite radio system 203 by (1) wireless transmission from the satellite provider's server 316 via the provider's wireless carrier network 317 (this method is labeled 320) or (2) transfer via a USB storage device 305 (this method is labeled 330).

Referring now to FIG. 4, there is presented an example of the web interface 400 that a user may employ to define their satellite radio filter file 304. The web interface 400 as shown in FIG. 4 comprises a dynamic webpage. The URL associated with the webpage will have a domain name that maps to the satellite provider's web server, as discussed in the detailed description of FIG. 3. Each time a user wishes to create, modify, or delete a particular filter file, they will be presented with web interface 400. In one aspect, the user may first, and prior to reaching web interface 400, encounter a user account homepage with their satellite radio provider upon logging into their account using the Internet and a web browser. After clicking on a particular hyperlink on their account page, the user will be provided a listing of the names of their existing filter files (the user presumably had already created) and options of (1) editing an existing filter file, (2) deleting an existing filter file, (3) creating a new filter file and (4) uploading an existing filter file stored on the local hard disk of the user's computing device. Upon selecting either options (1) or (3) by clicking the appropriate hyperlinks, the user will be presented with user interface 400. Each filter file in the aforementioned listing may have a user-specified name.

In the example of FIG. 4, web interface 400 is organized into three main columns, 401, 402, 403. In the illustrated example, column 401 contains checkboxes. The user can click to check or uncheck each checkbox. When checked, a checkbox will be marked by an “X” as shown in FIG. 4. When marked “X”, the associated channel number in the adjacent column 402 is blocked.

Column 402 contains a listing of all satellite radio channels' names to which the user has a subscription. As mentioned, each channel will have an associated checkbox in the adjacent column 401. Each listing in 402 will contain a channel name and number. In one example, each listing will also display some other key attribute information of the channel. For example, the listing might include a graphic image that is the channel's logo. The listing may also contain the word “XL” in brackets, as shown in FIG. 3 with “Channel B (XL)”. “XL” quickly indicates to the user that that particular satellite radio channel features extreme language content. At present, satellite radio providers already define for the user, which channels are “XL” and permit users to unsubscribe to all “XL” satellite radio channels. It is anticipated that users, in developing their filter file, will frequently wish to block particular channels containing XL content. Alternatively, instead of using the demarcation “XL”, the listing may use some other word or symbol to indicate that a satellite radio channel may contain extreme language content.

Column 403 contains descriptions of each corresponding satellite radio channel. In an example, the descriptions are approximately one hundred words in length, and describe the content played by each channel. Further, the description may include hyperlinks to the homepages of the associated satellite radio channel, or to other websites containing more detailed descriptions of the satellite radio channel. It is intended that these descriptions aid the user in developing their filter file by providing the user with sufficient information to determine whether to block a particular satellite radio channel.

While not shown in FIG. 4, in an example of the invention, both at the top and bottom of the webpage (if the user scrolls up or down), the user is presented with buttons to (1) submit the filter file as currently shown on the web interface 400, (2) delete the filter file as currently shown on the web interface 400, (3) uncheck all boxes, (4) revert back all changes made in the current session, (5) change the name of the filter file currently shown on web interface 400 and (6) download the filter file as shown on the web interface 400 to the local hard disk of the user's computing device.

Referring now to FIG. 5, there is shown an example of a vehicle radio system control panel 500. It will be appreciated that the precise layout of the radio system control panel 500 is within the discretion of the vehicle manufacturer. FIG. 5 is intended to provide only a generic layout of a control panel 500 of a vehicle radio system that is compatible with satellite radio technology and usable in accordance with the disclosed principles.

Element 510 refers generally to the portion of the control panel containing soft keys 600, and buttons and knobs for adjusting volume, radio channel selection, and playback options for CD or mp3 media. In the example shown in FIG. 5, element 510 is located in the lower portion of the control panel. Soft keys 600 are buttons the user can press to navigate the radio system's options and select the radio system's settings. In one exemplary arrangement, 510 will contain six or more soft keys. A description of how soft keys 600 are used as a component of the invention is provided in the detailed description of FIG. 6.

Element 520 refers generally to the display screen portion of the radio control panel 500. In the arrangement shown in FIG. 5, element 520 is located in the upper portion of the control panel. In a typical example, 520 is an LCD monitor. Section 522 of 520 displays information about the current time/date and the current radio station being broadcasted in the vehicle. The reference numeral 525 refers to the row listing of all radio channels neighboring the channel currently being broadcasted 521. The current channel 521 being broadcast is highlighted on the display 520 as shown in FIG. 5. In the example of FIG. 5, the current channel 521 being broadcast is channel “5”. All channels blocked by the currently active user-defined filter may be marked or highlighted as shown by element 524 in FIG. 5. In FIG. 5, for example, element 524 is channel “6”. In an alternative arrangement, blocked channels are not shown in the listing 525; only unblocked channels are listed. Section 523 of the screen display 520 shows the name of the currently active user-defined filter file. Note again, FIG. 5 only represents a generic vehicle radio control panel compatible with satellite radio technology.

Referring now to FIG. 6, there is shown the progression of soft keys 600 a user may encounter after pressing certain buttons. Elaborating, the soft keys 600 will perform certain functions for the user. Based on which soft keys 600 the user presses, the user's radio system will either perform certain actions or soft keys 600 will “progress” to present the user with new series of options. Thus, the progression of soft keys 600 can be thought of as a navigable menu. Based on which soft keys the user presses at each stage, the satellite radio system 203 either performs actions or the soft keys dynamically change their functionality. An example below clarifies this functionality. As shown in FIG. 6, the interface may contain at least six soft keys. The precise physical arrangement and size/shape of the soft keys is within the discretion of the discretion of the vehicle's manufacturer. The example below assumes six soft keys arranged and shaped as shown in FIG. 6.

Note that soft keys 600 are not physically labeled as they are in FIG. 6. Soft keys 600 are only labeled in FIG. 6 to aid in explaining their operation. Unlabeled soft keys in FIG. 6 do perform certain functions, but are unlabeled because they are not relevant to the instant example.

The user is initially presented with a “base” menu of soft keys 610 as shown in FIG. 6. Among these six base soft keys 610, soft key 611 “XM Opt” is relevant. If the user presses 611 “XM Opt”, they are presented with a new menu of soft keys 620, shown in the row below row 610. Soft keys 620 are physically the same soft keys as soft keys 610, but each soft key now performs a different function. Thus, by pressing “XM Opt”, the “base” menu soft keys 610 have progressed to become the “satellite radio” menu soft keys 620. The soft keys 620 allow the user to control their satellite radio system settings. The progression of soft keys can be considered a hierarchy, where the “base” menu of soft keys 610 is the starting point, and depending on which soft key the user presses, the soft keys progress down a particular path along the hierarchy of menus.

Note that with each progression of soft keys, the right-most soft key 601 “Back” is always present. If the user presses “Back”, the soft keys will progress up the hierarchy of soft keys, reverting back to the previous soft key menu. For example, pressing “Back” when the user is at the “satellite radio” menu 620 will cause the soft keys to revert back to the “base” menu of soft keys 610. If the user presses “Back” while at the “base” menu 610, the soft keys will maintain the same functionality since the “base” menu 610 is at the top of the hierarchy of options; the user cannot revert further.

Returning to the “satellite radio” menu 620, four soft keys are pertinent, 621, 622, 623, and 624. To edit an existing filter, a user first presses soft key 624 “Edit Filt” to indicate that they wish to make changes to their filter. Pressing 624 will temporarily unblock all channels. By temporarily unblocking all channels, the user may tune to channels that are defined as blocked in the filter file in order to make changes. If the user presses soft key 621 “Mark”, they will block or unblock the currently selected satellite radio channel. For example, if the radio is currently tuned to channel “5”, and channel “5” is not defined as blocked in the active filter file, then pressing 621 will block channel “5”. If the radio is currently tuned to channel “5” and channel “5” is defined as blocked in the active filter file, then pressing 621 will unblock channel “5”. When a user presses 621, the current satellite radio channel 521 will either appear as marked or unmarked to indicate its block status on the 520 display screen. If a user wishes to confirm their changes to the filter file, they may press 624 “Edit Filt”. The active filter file stored in the hard disk of the satellite radio system 203 will reflect changes made by the user since they last pressed 624 “Edit Filt”. Subsequently, all radio stations defined as blocked by the filter file will be skipped by the tuner.

In soft key menu 620, if the user presses soft key 621 “Sel Filt”, soft key menu 620 will progress down the hierarchy and become soft key menu 630. Soft key menu 630 is explained in greater detail in the next paragraph. Soft key 623 “XL On/Off” toggles whether all radio channels with XL content are blocked or unblocked. Note that pressing 623 will not modify the active filter file. However, all channels that are blocked (i.e. all channels deemed by the satellite radio provider to have XL content) will be appropriately marked on the 502 display screen.

Soft key menu 630 allows to the user to select a channel filter from those stored in the satellite radio system 203's hard disk. There are five pertinent soft keys: 631, 632, 633a, 633b, and 634. Pressing soft key 631 “Delete” will (1) turn off all filters and (2) delete the currently active filter file from the vehicle's satellite radio system's hard disk. Soft keys 633a “Up” and 633b “Down” permit the user to scroll through a listing of all filter files names stored on their satellite radio system's hard disk. The names of the filter files will be displayed in section 523 of the 520 display screen. The filter files are ordered alphabetically by default. In an example, the user may customize the displayed order of the filter files as shown on the 520 screen using a computing device and web interface 400 from FIG. 4. When a user has selected filter file they wish to load, pressing soft key 632 “Load” will activate the selected filter file. Pressing soft key 634 “New” will permit the user to create a new filter file by (1) turning off all filters, (2) automatically create a blank filter file in the satellite radio system 203's hard disk, (3) load the blank filter file such that is now active, and (4) revert back to soft key menu 620, with soft key 624 “Edit Filt” set such that the user can edit the blank filter file.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of providing user-defined satellite radio filtering in a satellite radio system comprising:
receiving at the satellite radio system a user-defined filter specifying one or more satellite channels to block;
recording an indicator of the one or more satellite channels to block; and
when receiving satellite radio signals, making the one or more satellite channels to block unavailable for listening by the user.

2. The method according to claim 1, wherein the step of receiving at the satellite radio system a user-defined filter specifying one or more satellite channels to block includes receiving the user-defined filter via a portable storage device.

3. The method according to claim 1, wherein the step of receiving at the satellite radio system a user-defined filter specifying one or more satellite channels to block includes receiving the user-defined filter via a wireless network.

4. The method according to claim 1, wherein the one or more satellite channels to block include at least on XL channel.

5. The method according to claim 1, wherein the step of receiving at the satellite radio system a user-defined filter specifying one or more satellite channels to block includes receiving the user-defined filter via a user interface of the satellite radio system.

6. The method according to claim 5, wherein the user interface of the satellite radio system includes one or more soft keys whose function is reassigned based upon the state of the interface.

7. The method according to claim 3, wherein the user-defined filter received via the wireless network originated on a user-controlled machine separate from the satellite radio system.

8. A computer-readable medium having thereon computer-executable instructions for providing user-defined satellite radio filtering in a satellite radio system, the instructions including:
instructions for receiving at the satellite radio system a user-defined filter specifying one or more satellite channels to block;
instructions for recording an indicator of the one or more satellite channels to block; and
instructions for making the one or more satellite channels unavailable for listening by the user when receiving satellite radio signals.

9. The computer-readable medium according to claim 8, wherein the instructions for receiving at the satellite radio system a user-defined filter specifying one or more satellite channels to block include instructions for receiving the user-defined filter via a portable storage device.

10. The computer-readable medium according to claim 8, wherein the instructions for receiving at the satellite radio system a user-defined filter specifying one or more satellite channels to block include instructions for receiving the user-defined filter via a wireless network.

11. The method according to claim 8, wherein the one or more satellite channels to block include at least on XL channel.

12. The computer-readable medium according to claim 1, wherein the instructions for receiving at the satellite radio system a user-defined filter specifying one or more satellite channels to block include instructions for receiving the user-defined filter via a user interface of the satellite radio system.

13. The computer-readable medium according to claim 12, wherein the user interface of the satellite radio system includes one or more soft keys whose function is reassigned based upon the state of the interface.

14. The computer-readable medium according to claim 10, wherein the user-defined filter received via the wireless network originated on a user-controlled machine separate from the satellite radio system.
